(19) United States
(12) Patent Application Publication
(10) Pub. No.: US 2020/0322850 A1
(43) Pub. Date: Oct. 8, 2020

(54) TECHNIQUES AND APPARATUSES FOR 5G TO 2G/3G FALLBACK WITHOUT ACCESSING AN LTE AIR INTERFACE

(71) Applicant: QUALCOMM Incorporated, San Diego, CA (US)

(72) Inventors: Xipeng ZHU, San Diego, CA (US); Gavin Bernard HORN, La Jolla, CA (US); Juan ZHANG, Beijing (CN); Haris ZISIMOPOULOS, London (GB); Srinivasan BALASUBRAMANIAN, San Diego, CA (US)

(21) Appl. No.: 16/652,873

(22) PCT Filed: Oct. 12, 2018
(86) PCT No.: PCT/CN2018/110100

§ 371 Date: Apr. 1, 2020

(30) Foreign Application Priority Data
Oct. 16, 2017 (CN) PCT/CN2017/106264

(51) Int. Cl. H04W 36/00; H04W 76/27; H04W 36/32; H04W 76/25; H04W 40/36

(52) U.S. Cl. CPC H04W 36/0022; H04W 36/0058; H04W 36/0085; H04W 40/36; H04W 36/32; H04W 76/25; H04W 76/27

(57) ABSTRACT

Certain aspects of the present disclosure generally relate to wireless communication. In some aspects, a user equipment may receive, from a 4G/LTE device and via a 5G/NR base station, a first handover command message identifying at least one of a measurement configuration or a measurement gap for identifying a 2G/3G cell, wherein the first handover command message is associated with a 5G/NR to 2G/3G handover of the UE via 4G/LTE; transmit, to the 4G/LTE device and via the 5G/NR base station, a measurement report regarding the 2G/3G cell based at least in part on the measurement configuration and/or the measurement gap; and tune to the 2G/3G cell based at least in part on a second handover message, received from the 4G/LTE device via the 5G/NR base station, for performance of the call via the 2G/3G cell. Numerous other aspects are provided.

### CROSS-REFERENCE TO RELATED APPLICATION

This application claims priority to PCT Application Number PCT/CN2017/106264, filed on Sep. 8, 2017, entitled “TECHNIQUES AND APPARATUSES FOR 5G TO 2G/3G FALLBACK WITHOUT ACCESSING AN LTE AIR INTERFACE,” which is hereby expressly incorporated by reference herein.

### FIELD OF THE DISCLOSURE

Aspects of the present disclosure generally relate to wireless communication, and more particularly to techniques and apparatuses for 5G to 2G/3G fallback without accessing a Long Term Evolution (LTE) air interface.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a new radio (NR) BS, a 5G Node B, and/or the like.

The above multiple access technologies have been adopted in various telecommunication standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication performed by a user equipment (UE) may include receiving, from a 4G/LTE device and via a 5G/NR base station, a first handover command message identifying at least one of a measurement configuration or a measurement gap for identifying a 2G/3G cell via which the UE is to perform a call, wherein the first handover command message is associated with a 5G/NR to 2G/3G handover of the UE via 4G/LTE; transmitting, to the 4G/LTE device and via the 5G/NR base station, a measurement report regarding the 2G/3G cell based at least in part on the measurement configuration and/or the measurement gap; and tuning to the 2G/3G cell based at least in part on a second handover message, received from the 4G/LTE device via the 5G/NR base station, for performance of the call via the 2G/3G cell.

In some aspects, a user equipment (UE) for wireless communication may include memory and one or more processors operatively coupled to the memory. The memory and the one or more processors may be configured to receive, from a 4G/LTE device and via a 5G/NR base station, a first handover command message identifying at least one of a measurement configuration or a measurement gap for identifying a 2G/3G cell via which the UE is to perform a call, wherein the first handover command message is associated with a 5G/NR to 2G/3G handover of the UE via 4G/LTE; transmit, to the 4G/LTE device and via the 5G/NR base station, a measurement report regarding the 2G/3G cell based at least in part on the measurement configuration and/or the measurement gap; and tune to the 2G/3G cell based at least in part on a second handover message, received from the 4G/LTE device via the 5G/NR base station, for performance of the call via the 2G/3G cell.

In some aspects, a non-transitory computer-readable medium may store one or more instructions for wireless communication. The one or more instructions, when executed by one or more processors of a user equipment (UE), may cause the one or more processors to receive, from a 4G/LTE device and via a 5G/NR base station, a first handover command message identifying at least one of a measurement configuration or a measurement gap for identifying a 2G/3G cell via which the UE is to perform a call, wherein the first handover command message is associated with a 5G/NR to 2G/3G handover of the UE via 4G/LTE; transmit, to the 4G/LTE device and via the 5G/NR base station, a measurement report regarding the 2G/3G cell based at least in part on the measurement configuration and/or the measurement gap; and tune to the 2G/3G cell based at least in part on a second handover message, received from the 4G/LTE device via the 5G/NR base station, for performance of the call via the 2G/3G cell.

In some aspects, an apparatus for wireless communication may include means for receiving, from a 4G/LTE device and via a 5G/NR base station, a first handover command message identifying at least one of a measurement configuration or a measurement gap for identifying a 2G/3G cell via which the apparatus is to perform a call, wherein the first handover command message is associated with a 5G/NR to 2G/3G handover of the apparatus via 4G/LTE; means for transmitting, to the 4G/LTE device and via the 5G/NR base station, a measurement report regarding the 2G/3G cell based at least in part on the measurement configuration and/or the measurement gap; and means for tuning to the 2G/3G cell based at least in part on a second handover message, received from the 4G/LTE device via the 5G/NR base station, for performance of the call via the 2G/3G cell.

In some aspects, a method of wireless communication performed by a 4G/LTE device may include providing a first message identifying a measurement configuration for identifying a 2G/3G cell via which a UE is to perform a call, wherein the first message is provided to the UE via a 5G/NR base station; receiving a measurement report regarding the 2G/3G cell based at least in part on the measurement configuration and via the 5G/NR base station; and providing a second message to configure handover of the UE to the 2G/3G cell to perform the call, wherein the second message is provided to the UE via the 5G/NR base station.

In some aspects, a 4G/LTE device for wireless communication may include memory and one or more processors operatively coupled to the memory. The memory and the one or more processors may be configured to provide a first message identifying a measurement configuration for identifying a 2G/3G cell via which a UE is to perform a call, wherein the first message is provided to the UE via a 5G/NR base station; receive a measurement report regarding the 2G/3G cell based at least in part on the measurement configuration and via the 5G/NR base station; and provide a second message to configure handover of the UE to the 2G/3G cell to perform the call, wherein the second message is provided to the UE via the 5G/NR base station.

In some aspects, a non-transitory computer-readable medium may store one or more instructions for wireless communication. The one or more instructions, when executed by one or more processors of a 4G/LTE device, may cause the one or more processors to provide a first message identifying a measurement configuration for identifying a 2G/3G cell via which a UE is to perform a call, wherein the first message is provided to the UE via a 5G/NR base station; receive a measurement report regarding the 2G/3G cell based at least in part on the measurement configuration and via the 5G/NR base station; and provide a second message to configure handover of the UE to the 2G/3G cell to perform the call, wherein the second message is provided to the UE via the 5G/NR base station.

In some aspects, an apparatus for wireless communication may include means for providing a first message identifying a measurement configuration for identifying a 2G/3G cell via which a UE is to perform a call, wherein the first message is provided to the UE via a 5G/NR base station; means for receiving a measurement report regarding the 2G/3G cell based at least in part on the measurement configuration and via the 5G/NR base station; and means for providing a second message to configure handover of the UE to the 2G/3G cell to perform the call, wherein the second message is provided to the UE via the 5G/NR base station.

Aspects generally include a method, apparatus, system, computer program product, non-transitory computer-readable medium, user equipment, base station, wireless communication device, and processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with certain aspects of the present disclosure.

FIG. 2 is a block diagram conceptually illustrating an example of a base station in communication with a user equipment (UE) in a wireless communication network, in accordance with certain aspects of the present disclosure.

FIGS. 3A and 3B are diagrams illustrating examples of a call flow for 5G to 2G/3G fallback without accessing an LTE air interface, in accordance with various aspects of the present disclosure.

FIGS. 4A and 4B are diagrams illustrating examples of another call flow for 5G to 2G/3G fallback without accessing an LTE air interface, in accordance with various aspects of the present disclosure.

FIG. 5 is a diagram illustrating an example of yet another call flow for 5G to 2G/3G fallback without accessing an LTE air interface, in accordance with various aspects of the present disclosure.

FIG. 6 is a diagram illustrating an example process performed, for example, by a user equipment, in accordance with various aspects of the present disclosure.

FIG. 7 is a diagram illustrating an example process performed, for example, by a 4G/LTE device, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It is noted that while aspects may be described herein using terminology commonly associated with 3G and/or 4G wireless technologies, aspects of the present disclosure can be applied in other generation-based communication systems, such as 5G and later, including NR technologies.

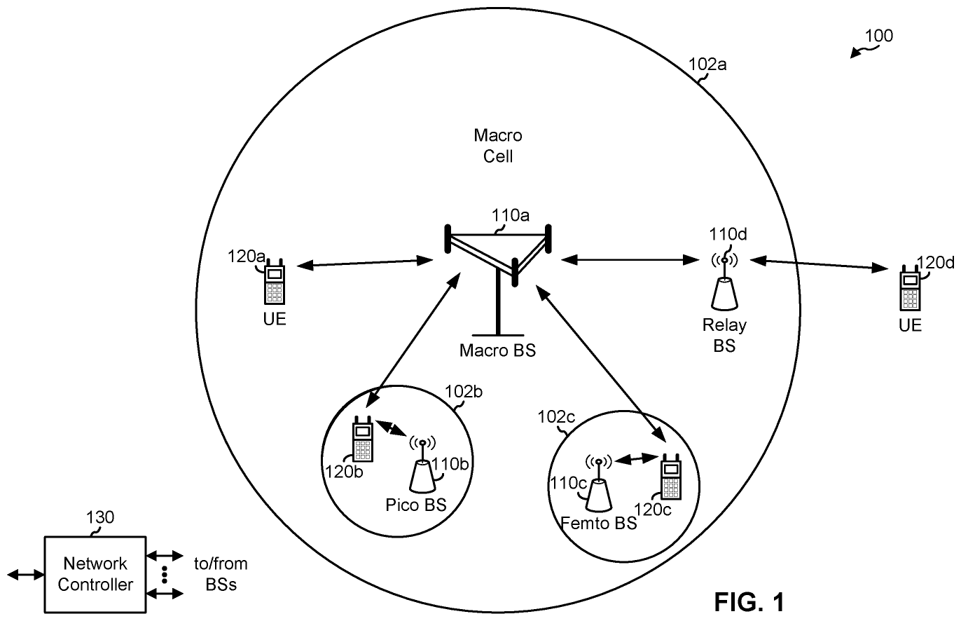

FIG. 1 is a diagram illustrating a network 100 in which aspects of the present disclosure may be practiced. The network 100 may be an LTE network or some other wireless network, such as a 5G or NR network. Wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the access network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, such as sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, access to the air interface may be scheduled, wherein a scheduling entity (e.g., a base station) allocates resources for communication among some or all devices and equipment within the scheduling entity's service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity.

Base stations are not the only entities that may function as a scheduling entity. That is, in some aspects, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

As indicated above, FIG. 1 is provided merely as an example. Other examples are possible and may differ from what was described with regard to FIG. 1.

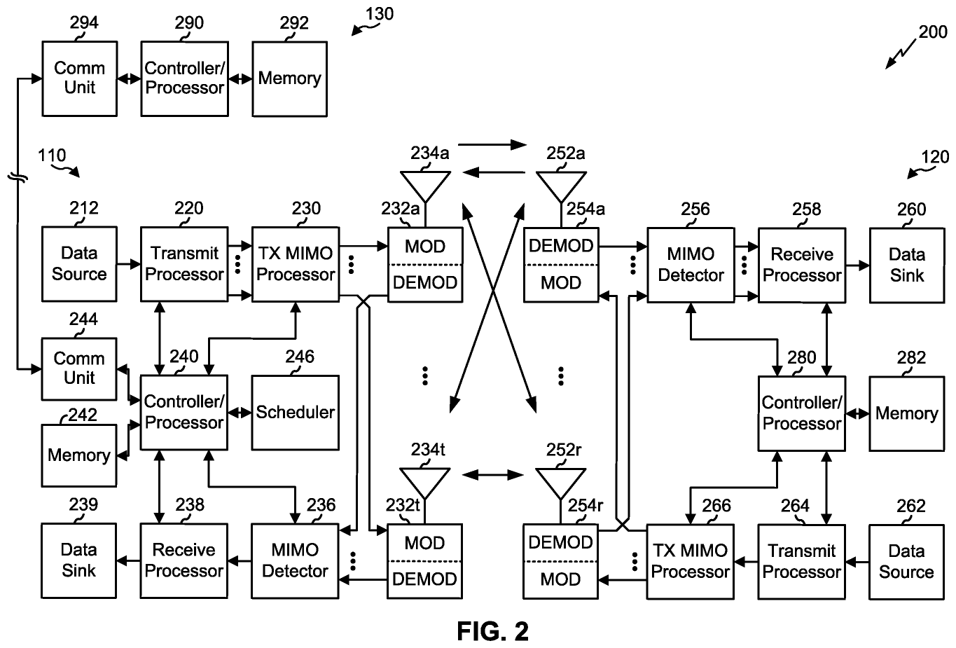

FIG. 2 shows a block diagram of a design 200 of BS 110 and UE 120, which may be one of the base stations and one of the UEs in FIG. 1. BS 110 may be equipped with T antennas 234a through 234t, and UE 120 may be equipped with R antennas 252a through 252r, where in general T≥1 and R≥1.

At BS 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to certain aspects described in more detail below, the synchronization signals can be generated with location encoding to convey additional information.

At UE 120, antennas 252a through 252r may receive the downlink signals from BS 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to BS 110. At BS 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. BS 110 may include communication unit 244 and communicate to network controller 130 via communication unit 244. Network controller 130 may include communication unit 294, controller/processor 290, and memory 292.

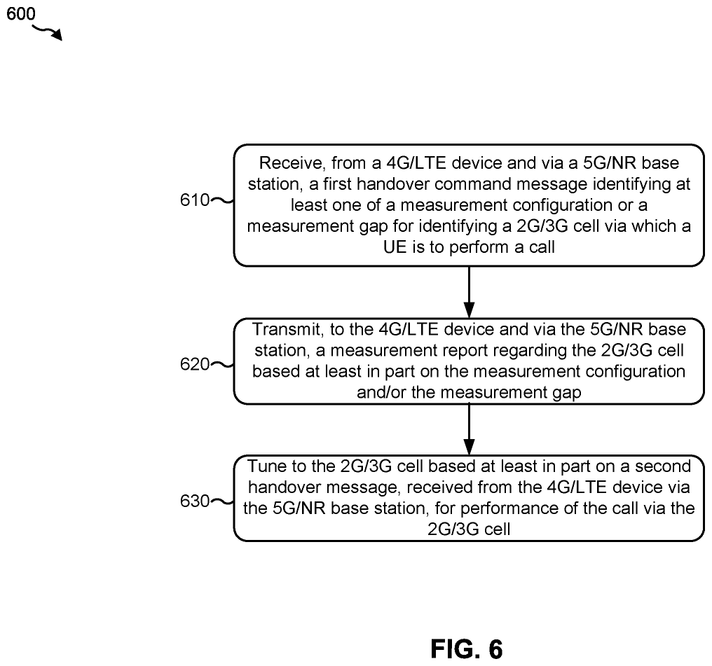

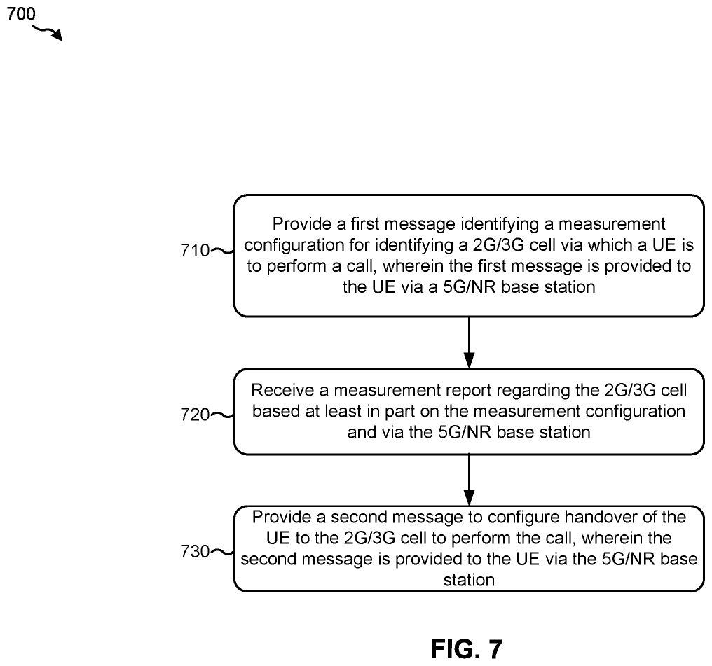

In some aspects, one or more components of UE 120 may be included in a housing. Controller/processor 240 of BS 110, controller/processor 280 of UE 120, and/or any other component(s) of FIG. 2 may perform one or more techniques associated with 5G to 2G/3G fallback without accessing an LTE air interface, as described in more detail elsewhere herein. For example, controller/processor 240 of BS 110, controller/processor 280 of UE 120, and/or any other component(s) of FIG. 2 may perform or direct operations of, for example, process 600 of FIG. 6, process 700 of FIG. 7, and/or other processes as described herein. Memories 242 and 282 may store data and program codes for BS 110 and UE 120, respectively. A scheduler 246 may schedule UEs for data transmission on the downlink and/or uplink.

In some aspects, UE 120 may include means for receiving, from a 4G/LTE device and via a 5G/NR base station, a first handover command message identifying at least one of a measurement configuration or a measurement gap for identifying a 2G/3G cell via which the apparatus is to perform a call; means for transmitting, to the 4G/LTE device and via the 5G/NR base station, a measurement report regarding the 2G/3G cell based at least in part on the measurement configuration and/or the measurement gap; means for tuning to the 2G/3G cell based at least in part on a second handover message, received from the 4G/LTE device via the 5G/NR base station, for performance of the call via the 2G/3G cell; means for providing, to a 4G/LTE network device via the 4G/LTE device, a tracking area update (TAU) message for configuration of a packet-switched handover of the UE to the 2G/3G cell; means for performing a routing area update (RAU) for the packet-switched handover of the UE to the 2G/3G cell based at least in part on receiving a TAU accept message with the second handover message; means for receiving a plurality of first handover command messages for a plurality of corresponding 2G/3G cells, wherein the plurality of corresponding 2G/3G cells includes the 2G/3G cell and wherein the first handover command corresponding to the 2G/3G cell is included in the plurality of first handover command messages; means for selecting the 2G/3G cell from the plurality of corresponding 2G/3G cells based at least in part on measurements associated with the plurality of corresponding 2G/3G cells; means for releasing an air interface connection with the 5G/NR base station; and/or the like. In some aspects, such means may include one or more components of UE 120 described in connection with FIG. 2.

In some aspects, BS 110 (e.g., a 4G/LTE device) may include means for providing a first message identifying a measurement configuration for identifying a 2G/3G cell via which a UE is to perform a call, wherein the first message is provided to the UE via a 5G/NR base station; means for receiving a measurement report regarding the 2G/3G cell based at least in part on the measurement configuration and via the 5G/NR base station; means for providing a second message to configure handover of the UE to the 2G/3G cell to perform the call, wherein the second message is provided to the UE via the 5G/NR base station; means for providing a plurality of first messages identifying measurement configurations of a plurality of 2G/3G cells; means for performing a multi-target handover preparation procedure with regard to the plurality of 2G/3G cells; means for receiving, via the 5G/NR base station, a tracking area update (TAU) message for configuration of a packet-switched handover of the UE to the 2G/3G cell; means for configuring the packet-switched handover of the UE to the 2G/3G cell; means for providing a TAU accept message to cause the packet-switched handover of the UE to the 2G/3G cell; and/or the like. In some aspects, such means may include one or more components of BS 110 described in connection with FIG. 2.

As indicated above, FIG. 2 is provided merely as an example. Other examples are possible and may differ from what was described with regard to FIG. 2.

While aspects of the examples described herein may be associated with LTE technologies, aspects of the present disclosure may be applicable with other wireless communication systems, such as NR or 5G technologies.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). In aspects, NR may utilize OFDM with a CP (herein referred to as cyclic prefix OFDM or CP-OFDM) and/or SC-FDM on the uplink, may utilize CP-OFDM on the downlink and include support for half-duplex operation using time division duplexing (TDD). In aspects, NR may, for example, utilize OFDM with a CP (herein referred to as CP-OFDM) and/or discrete Fourier transform spread orthogonal frequency-division multiplexing (DFT-s-OFDM) on the uplink, may utilize CP-OFDM on the downlink and include support for half-duplex operation using TDD. NR may include Enhanced Mobile Broadband (eMBB) service targeting wide bandwidth (e.g., 80 megahertz (MHz) and beyond), millimeter wave (mmW) targeting high carrier frequency (e.g., 60 gigahertz (GHz)), massive MTC (mMTC) targeting non-backward compatible MTC techniques, and/or mission critical targeting ultra reliable low latency communications (URLLC) service.

A single component carrier bandwidth of 100 MHz may be supported. NR resource blocks may span 12 sub-carriers with a sub-carrier bandwidth of 75 kilohertz (kHz) over a 0.1 ms duration. Each radio frame may include 50 subframes with a length of 10 ms. Consequently, each subframe may have a length of 0.2 ms. Each subframe may indicate a link direction (e.g., DL or UL) for data transmission and the link direction for each subframe may be dynamically switched. Each subframe may include downlink/uplink (DL/UL) data as well as DL/UL control data.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. In some aspects, NR may support a different air interface, other than an OFDM-based interface. NR networks may include entities, such as central units or distributed units.

The radio access network (RAN) may include a central unit (CU) and distributed units (DUs). A NR BS (e.g., gNB, 5G Node B, Node B, transmit receive point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity, but not used for initial access, cell selection/reselection, or handover. In some cases, DCells may not transmit synchronization signals. In some cases, DCells may transmit synchronization signals. NR BSs may transmit downlink signals to UEs indicating the cell type. Based at least in part on the cell type indication, the UE may communicate with the NR BS. For example, the UE may determine NR BSs to consider for cell selection, access, handover, and/or measurement based at least in part on the indicated cell type.

A UE may perform a fallback from a first radio access technology (RAT), such as NR or LTE, to a second RAT, such as LTE, 2G, or 3G. For example, a 5G/NR deployment may not support Voice over New Radio (VoNR), so a UE associated with a call using the 5G/NR deployment may perform a fallback to a 4G/LTE base station so the call can be performed using Voice over LTE (VoLTE). However, in some cases, the 4G/LTE base station may not be configured to provide VoLTE, or may not be capable of supporting quality of service (QoS) requirements associated with VoLTE. In such a case, the UE may perform another fallback to a 2G/3G cell, which takes a significant amount of time, uses network resources, and degrades user experience.

Some techniques and apparatuses described herein provide for a fallback from 5G/NR to 2G/3G without using an LTE air interface. In other words, the UE may perform the fallback to 2G/3G without accessing an air interface provided by the 4G/LTE base station. For example, some techniques and apparatuses described herein may provide a tunneling mechanism (e.g., a radio resource control (RRC) tunneling mechanism) for configuration messages, reporting messages, and/or non-access stratum (NAS) messages related to performing a fallback. In this way, network resources of the 4G/LTE base station and the UE may be conserved. Furthermore, a delay associated with the fallback to 2G/3G may be reduced.

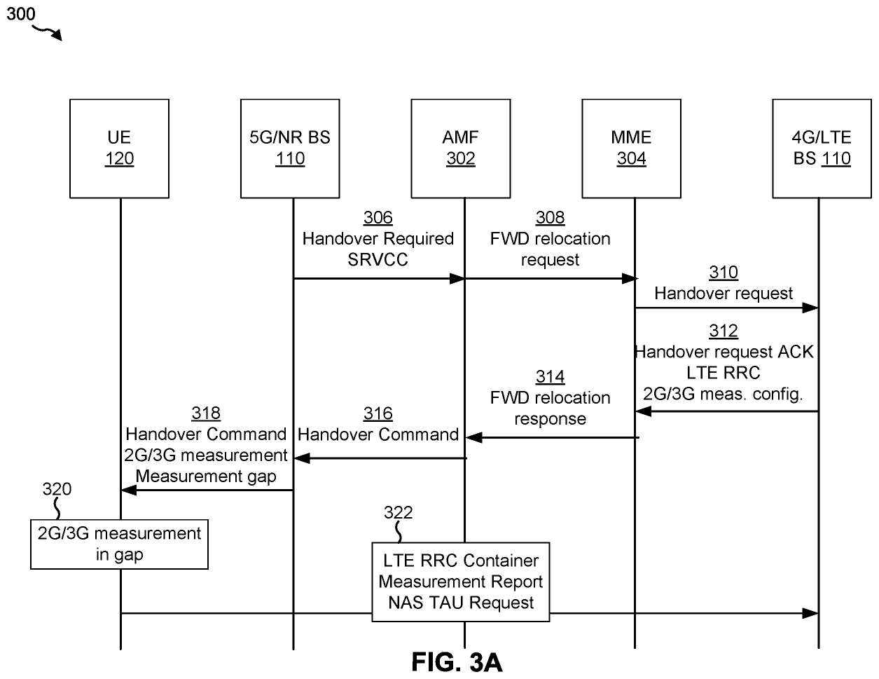

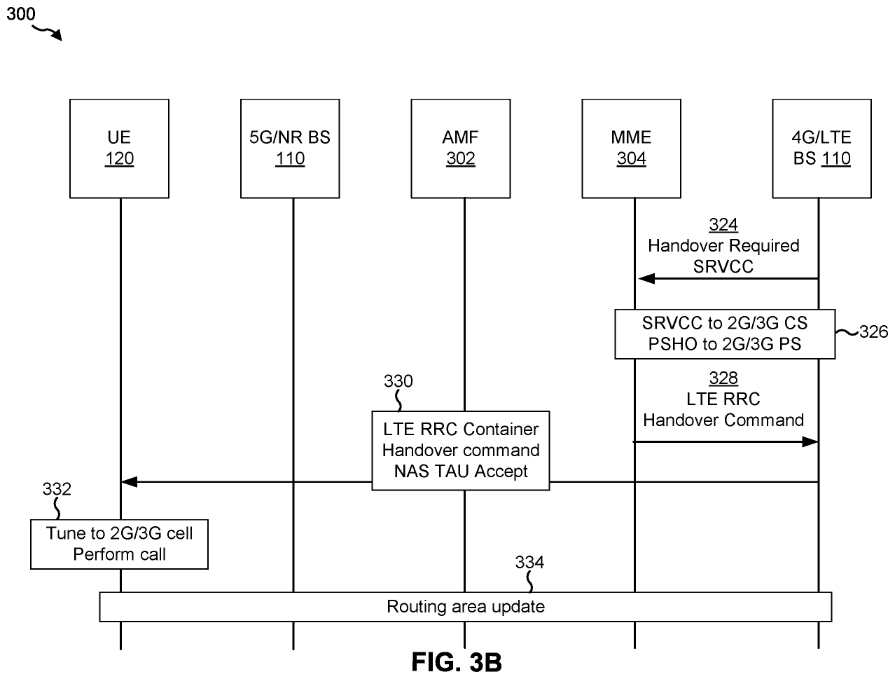

FIGS. 3A and 3B are diagrams illustrating examples 300 of a call flow for 5G to 2G/3G two-step fallback, in accordance with various aspects of the present disclosure. As shown, examples 300 may include an Access and Mobility Management Function (AMF) 302 and a mobility management entity (MME) 304. AMF 302 and MME 304 may store mobility information and UE information (e.g., UE contexts) for 5G/NR UEs and 4G/LTE UEs, respectively. Additionally, or alternatively, AMF 302 and MME 304 may handle handover-related communication and configuration for UEs being handed over from one BS and/or RAT to another BS and/or RAT.

As shown in FIG. 3A, and by reference number 306, a 5G/NR BS 110 (e.g., a gNB, a 5G NB, etc.) may provide a first handover command message to the AMF 302. For example, the first handover command message may indicate that a UE 120 is to be handed over from the 5G/NR BS 110 to a 4G/LTE BS 110. In some aspects, the 5G/NR BS 110 may provide the first handover command message based at least in part on determining that the UE 120 is placing or receiving a call, and based at least in part on the 5G/NR BS 110 not supporting VoNR. As further shown, in some aspects, the first handover command message may include a Single Radio Voice Call Continuity (SRVCC) request.

As shown by reference number 308, the AMF 302 may provide a forward relocation request (shown as FWD relocation request) to the MME 304 based at least in part on the first handover command message. The forward relocation request may initiate a fallback procedure from 5G/NR to 4G/LTE, and/or from 4G/LTE to 2G/3G. For example, the forward relocation request may identify the UE 120 and may indicate that the UE 120 is to be handed over from the 5G/NR BS 110 to a 4G/LTE BS 110 and/or a 2G/3G cell provided by a 2G/3G BS 110.

As shown by reference number 310, the MME 304 may provide a handover request to the 4G/LTE BS 110. For example, the handover request may indicate that the UE 120 is to be handed over from the 5G/NR BS 110 to a 2G/3G BS 110 (not shown) that provides a 2G/3G cell.

As shown by reference number 312, the 4G/LTE BS 110 may provide an acknowledgment of the handover request. As further shown, the acknowledgment may include information identifying a 2G/3G measurement configuration. For example, the 4G/LTE BS 110 may configure the UE 120 to perform particular measurements to identify a suitable 2G/3G cell for handover. As further shown, the 4G/LTE BS 110 may encapsulate the acknowledgment in an LTE RRC container. The LTE RRC container may provide for tunneling of the 2G/3G measurement configuration to the UE 120 without using an LTE air interface to provide the 2G/3G measurement configuration. For example, the LTE RRC container may be transparent to the 5G/NR BS 110.

As shown by reference number 314, the MME 304 may provide a forward relocation response to the AMF 302. As shown by reference number 316, the AMF 302 may provide a handover command to the 5G/NR BS 110. For example, the forward relocation response and the handover command may include the 2G/3G measurement configuration.

As shown by reference number 318, the 5G/NR BS 110 may provide the handover command to the UE 120. As shown, the handover command may include the 2G/3G measurement configuration. As further shown, the handover command may identify a measurement gap. In some aspects, the handover command may be provided in a target-to-source transparent container, or a container that is transparent to the 5G/NR BS 110. For example, the 5G/NR BS 110 may determine the measurement gap, and may provide scheduling information to the UE 120 identifying the measurement gap. In this way, the 2G/3G measurement configuration is provided from the 4G/LTE BS 110 to the UE 120 without using an LTE air interface, which improves speed and efficiency of performing a fallback to 2G/3G.

As shown by reference number 320, the UE 120 may perform the 2G/3G measurement identified by the 2G/3G measurement configuration. For example, the UE 120 may perform the 2G/3G measurement in the measurement gap to determine a target 2G/3G cell for performing the fallback. In some aspects, the UE 120 may perform measurements with regard to multiple, different 2G/3G cells, and may select a best cell, as described in more detail elsewhere herein.

As shown by reference number 322, the UE 120 may provide a measurement report to the 4G/LTE BS 110 via the 5G/NR BS 110, the AMF 302, and the MME 304. For example, the UE 120 may provide the measurement report in an LTE RRC container, which may be transparent to the 5G/NR BS 110. Additionally, or alternatively, the UE 120 may provide the measurement report in a source-to-target transparent container. In this way, the UE 120 provides the measurement report to the 4G/LTE BS 110 using a tunnel via the 5G/NR BS 110, which reduces reliance on the 4G/LTE air interface to perform the fallback from 4G/LTE to 2G/3G.

As further shown, the UE 120 may provide a tracking area update (TAU) request using a non-access stratum (NAS) messaging protocol. For example, the UE 120 may provide the TAU request in an LTE RRC container, as shown. The UE 120 may provide the TAU request to trigger a packet-switched handover of the UE 120 from 5G/NR to 2G/3G. For example, the UE 120 may provide the TAU request in association with UE context information so that the MME 304 can configure the packet-switched handover of the UE 120.

As shown in FIG. 3B, and by reference number 324, the 4G/LTE BS 110 may provide a handover command message to the MME 304 to trigger handover to the 2G/3G cell identified by the measurement report. For example, the handover command may include a SRVCC message to configure handover of the UE 120 from the 5G/NR BS 110 to a 2G/3G cell.

As shown by reference number 326, the 4G/LTE BS 110 and the MME 304 may configure an SRVCC handover of the UE 120 to a 2G/3G circuit-switched (CS) network. In this way, a two-step fallback is performed so that a call can be performed using the 2G/3G CS network. Furthermore, the 4G/LTE BS 110 and the MME 304 may configure a packet-switched handover (PSHO) of the UE 120 to a 2G/3G packet-switched (PS) network. For example, the 4G/LTE BS 110 and the MME 304 may configure the PSHO when concurrent PS and CS communication on the 2G/3G network is supported.

As shown by reference number 328, the MME 304 may provide a handover command to the 4G/LTE BS 110 in an LTE RRC container. For example, the MME 304 may provide the handover command to the 4G/LTE BS 110 for the 4G/LTE BS 110 to forward to the UE 120. Furthermore, the MME 304 may provide the handover command in the RRC transparent container to enable tunneling of the handover command to the UE 120 via the 5G/NR BS 110.

As shown by reference number 330, the 4G/LTE BS 110 may provide the handover command to the UE 120 via the 5G/NR BS 110. By providing the handover command in the LTE RRC container and via the 5G/NR BS 110, the 4G/LTE BS 110 conserves resources that would otherwise be used to establish an LTE air interface with the UE 120 as part of the two-step handover. As further shown, the 4G/LTE BS 110 may provide a TAU accept message in a NAS message. For example, the TAU accept message may be encapsulated in the LTE RRC container. Thus, the TAU accept message may be provided to the UE 120 via the 5G/NR BS 110 without using an LTE air interface. The TAU accept message may indicate that the UE 120 is to perform a PS handover to the 2G/3G cell, as described in more detail below.

As shown by reference number 332, the UE 120 may tune to the 2G/3G cell, and may perform a call via the 2G/3G cell. In this way, a two-step handover from the 5G/NR BS 110 to the 2G/3G cell is configured by a 4G/LTE BS 110 without using an air interface of the 4G/LTE BS 110, which conserves radio resources and improves speed of the two-step handover procedure.

As shown by reference number 334, the UE 120 may perform a routing area update. For example, the UE 120 may perform the routing area update to perform the PS handover from the 5G/NR BS 110 to the 2G/3G cell. In this way, a PS handover from the 5G/NR BS 110 to the 2G/3G cell is configured and performed without using the LTE air interface, which improves speed and efficiency of the PS handover.

After the call ends, the UE 120 may return to LTE operation. After returning to LTE operation, the UE 120 may reselect to 5G/NR operation and/or may be transferred to 5G operation by the LTE network (e.g., the MME 304 and/or the 4G/LTE BS 110).

As indicated above, FIGS. 3A and 3B are provided as examples. Other examples are possible and may differ from what was described with respect to FIGS. 3A and 3B.

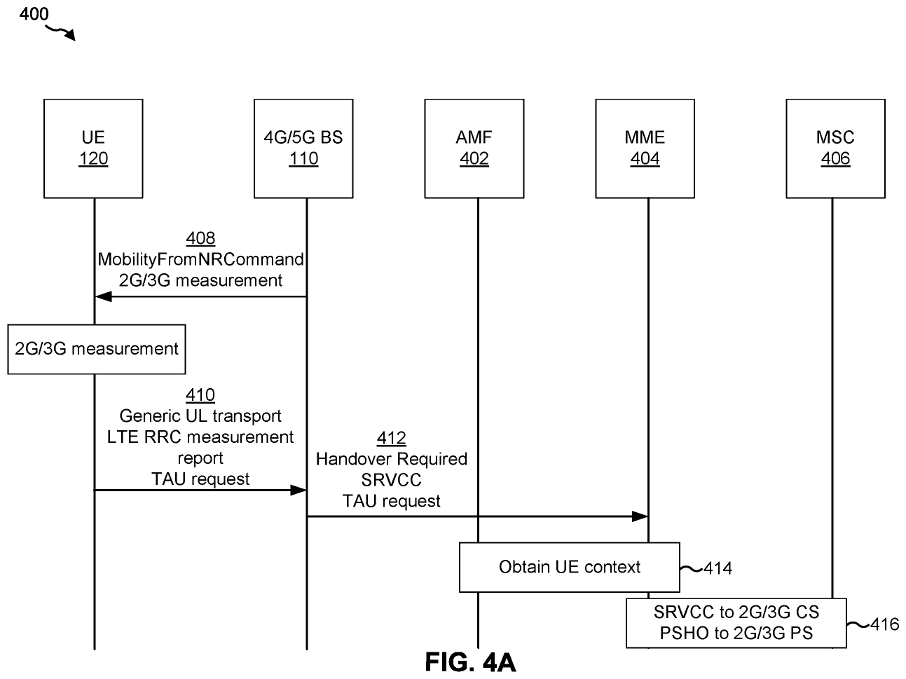

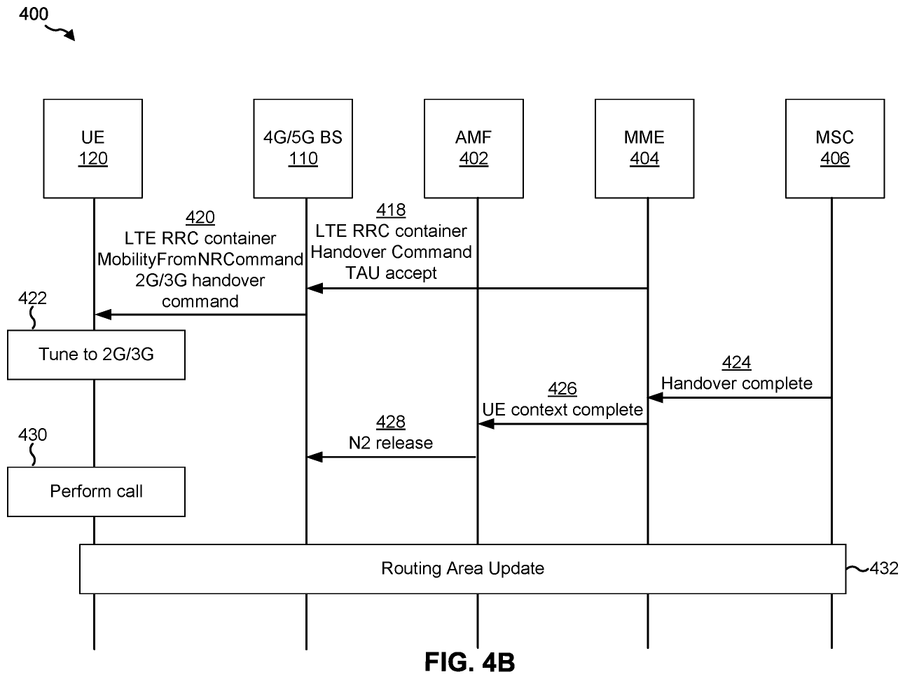

FIGS. 4A and 4B are diagrams illustrating examples 400 of another call flow for 5G to 2G/3G two-step fallback, in accordance with various aspects of the present disclosure. FIGS. 4A and 4B show a two-step fallback procedure wherein a 4G/LTE BS and a 5G/NR BS are collocated. For example, the 4G/LTE BS may be a component of the 5G/NR BS, or the 5G/NR BS may be a component of the 4G/LTE BS. In FIGS. 4A and 4B, the collocated BS is shown as 4G/5G BS 110. As shown, example 400 includes an AMF 402 and an MME 404, which may be similar to AMF 302 and MME 304 of FIGS. 3A and 3B. Furthermore, example 400 includes a mobile switching center (MSC) 406, which may perform mobility and handover functions for a 2G/3G network. In some aspects, one or more operations described as in example 400 as being performed by the 4G/5G BS 110 may be performed by the MME 304 and/or any other device of FIG. 1, 2, 3A, or 3B.

As shown by reference number 408, the 4G/5G BS 110 may provide a first handover command message (e.g., MobilityFromNRCommand) to a UE 120. For example, the first handover command message may identify a 2G/3G measurement configuration. Notably, no handover message or handover request needs to be provided from a 4G/LTE BS 110 to a 5G/NR BS 110 when the 4G/LTE BS and the 5G/NR BS are collocated, which conserves backhaul resources of the network. As shown, the UE 120 may perform a 2G/3G measurement based at least in part on the first handover command message. In some aspects, the UE 120 may perform the 2G/3G measurement without receiving a handover command message. For example, the UE 120 may perform the 2G/3G measurement periodically, based at least in part on a measurement event, and/or the like.

As shown by reference number 410, the UE 120 may provide a measurement report to the 4G/5G BS 110. For example, the measurement report may be encapsulated in an LTE RRC container, which may enable tunneling of the measurement report from the UE 120 to the 4G/5G BS 110 without using an LTE air interface. As further shown, the UE 120 may provide a TAU request to configure a PS handover of the UE 120 from the 4G/5G BS 110 to a 2G/3G cell.

As shown by reference number 412, the 4G/5G BS 110 may provide a first handover command message to an MME 404 to configure handover of the UE 120. Here, since the 4G/5G BS 110 is collocated, no backhaul messaging is needed between a 4G/LTE BS and a 5G/NR BS, which conserves network resources. As further shown, the 4G/5G BS 110 may provide the TAU request to the MME 404 for configuration of the PS handover of the UE 120. In some aspects, the first handover command message may include a forward relocation request. In some aspects, the first handover command message may indicate a target identifier (e.g., of the 2G/3G cell to which the UE 120 is to be handed over). In some aspects, the first handover command message may be transmitted in a transparent container (e.g., an LTE RRC container). In some aspects, the first handover command message may include a SRVCC handover indication.

As shown by reference number 414, the MME 404 may obtain UE context information from the AMF 402 to configure the PS handover. For example, the AMF 402 may store the UE context information based at least in part on an active 5G/NR connection with the UE 120.

As shown by reference number 416, the MME 404 may configure a CS handover of the UE 120 (e.g., a SRVCC handover to the 2G/3G CS network) and/or a PS handover of the UE 120 (e.g., a PSHO to the 2G/3G PS network). For example, the MME 404 may configure a mobile switching center (MSC) 406 to perform the handover (e.g., by providing information identifying the UE 120 and/or UE context information for the UE 120). In some aspects, the MSC 406 may configure a target 2G/3G cell for the handover. For example, the MSC 406 may provide UE context information for the UE 120, may provide information identifying the UE 120, and/or the like.

As shown in FIG. 4B, and by reference number 418, the MME 404 may provide a handover command to the 4G/5G BS 110 to cause the handover of the UE 120 to be performed. For example, the MME 404 may provide the handover command in a container that is transparent to the 4G/5G BS 110, thereby eliminating a need for an LTE air interface with the UE 120. As further shown, the MME 404 may provide a TAU accept message indicating that the UE 120 is to perform a PS handover to the 2G/3G cell. In some aspects, the handover command may include a forward relocation response. In some aspects, the MME 404 may provide the handover command to the 4G/5G BS 110 via the AMF 402. In some aspects, the MME 404 may provide a forward relocation response to the AMF 402, and the AMF 402 may generate the handover command based at least in part on the forward relocation response.

As shown by reference number 420, the 4G/5G BS 110 may provide the handover command to the UE 120. For example, the 4G/5G BS 110 may provide the handover command via a 5G/NR air interface, thereby eliminating a need for an LTE air interface with the UE 120. Furthermore, the handover command may identify a target 2G/3G cell, which may be selected by the MME 404 based at least in part on the measurement report.

As shown by reference number 422, the UE 120 may tune to the target 2G/3G cell, and may perform the call (not shown). In this way, the UE 120 performs a two-step handover from 5G/NR to 2G/3G without connecting to an LTE network during the two-step handover, which improves speed and efficiency of the two-step handover.

As shown by reference number 424, the MSC 406 may provide information to the MME 404 indicating that handover of the UE 120 is complete. For example, the MSC 406 may determine that handover is complete based at least in part on information received from a 2G/3G BS that provides the target 2G/3G cell. As shown by reference number 426, the MME 404 may provide information to the AMF 402 indicating that the UE context associated with UE 120 is complete (e.g., indicating that the AMF 402 can delete the UE context associated with UE 120. As shown by reference number 428, the AMF 402 may provide a message indicating to release an interface between the 4G/5G BS 110 and the UE 120.

As shown by reference number 430, the UE 120 may perform the call via the 2G/3G cell. In this way, handover from a 4G/5G BS 110 to a 2G/3G cell is realized without an intermediate step of connecting with an LTE air interface. As shown by reference number 432, the UE 120 may perform a routing area update. For example, the UE 120 may perform the routing area update to perform a PS handover from the 4G/5G BS 110 to the 2G/3G cell. In this way, the UE 120 may transfer packet-switched operation of the UE 120 to a 2G/3G cell, which may conserve network resources of the 4G/5G BS 110.

As indicated above, FIGS. 4A and 4B are provided as examples. Other examples are possible and may differ from what was described with respect to FIGS. 4A and 4B.

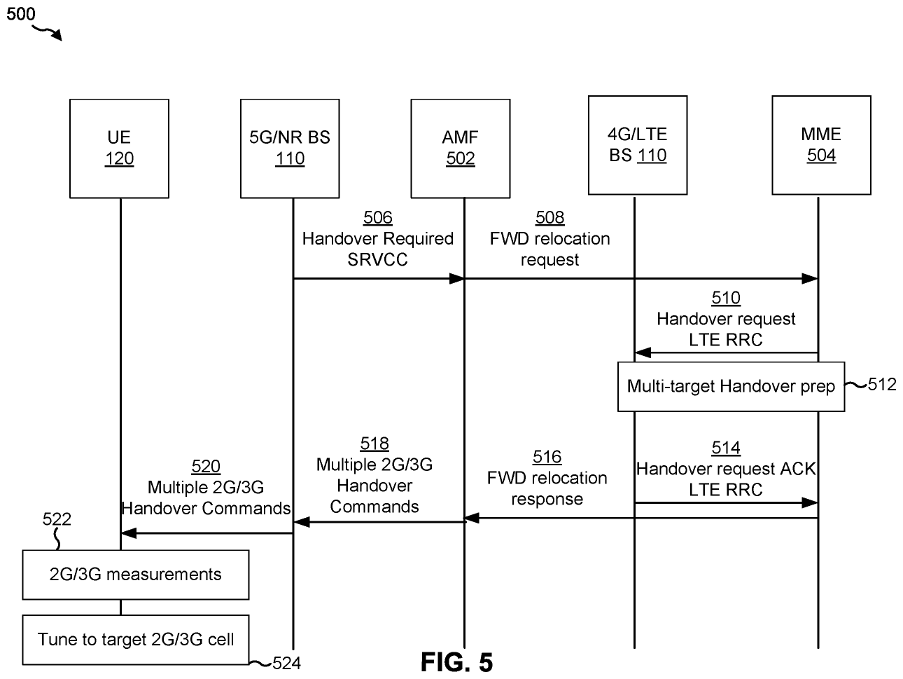

FIG. 5 is a diagram illustrating an example 500 of a call flow for 5G to 2G/3G two-step fallback, in accordance with various aspects of the present disclosure. As shown, example 500 includes an AMF 502 and an MME 504, which may be similar to AMF 302/402 and MME 304/404. FIG. 5 describes an example wherein the UE 120 performs handover based at least in part on multiple handover commands.

As shown by reference number 506, a 5G/NR BS 110 may provide a first handover command message to the AMF 502, as described in more detail elsewhere herein. As shown by reference number 508, the AMF 502 may provide a forward relocation request to the MME 504, as is also described in more detail elsewhere herein.

As shown by reference number 510, the MME 504 may provide a handover request in an LTE RRC container to the 4G/LTE BS 110. As shown by reference number 512, the MME 504 and/or the 4G/LTE BS 110 may perform multi-target handover preparation. For example, the MME 504 and/or the 4G/LTE BS 110 may select one or more target 2G/3G base stations or cells, and may provide handover information to the one or more target 2G/3G base stations or cells. In some aspects, the MME and/or the 4G/LTE BS 110 may perform the multi-target handover preparation by providing information to an MSC, a radio network controller, and/or the like.

As shown by reference number 514, the 4G/LTE BS 110 may provide a handover request acknowledgment to the MME 504 in an LTE RRC container, as described in more detail elsewhere herein. The handover request acknowledgment may identify the one or more target 2G/3G base stations or cells that were identified as part of the multi-target handover preparation.

As shown by reference number 516, the MME 504 may provide a forward relocation response to the AMF 502. The forward relocation response may identify the one or more target 2G/3G base stations or cells. As shown by reference number 518, the AMF 502 may provide multiple, different 2G/3G handover commands to the 5G/NR BS 110, and, as shown by reference number 520, the 5G/NR BS 110 may provide the multiple, different 2G/3G handover commands to the UE 120.

As shown by reference number 522, the UE 120 may perform 2G/3G measurements based at least in part on the multiple, different 2G/3G handover commands. For example, the UE 120 may perform measurements with regard to the one or more target 2G/3G base stations or cells to identify a target cell. As shown by reference number 524, the UE 120 may tune to a target 2G/3G cell. For example, the UE 120 may enforce one of the multiple, different 2G/3G handover commands corresponding to the target 2G/3G cell. In this way, the UE 120 selects a target cell based at least in part on multiple, different handover commands, which conserves network resources that would otherwise be used by the MME 504 to select the target 2G/3G cell.

As indicated above, FIG. 5 is provided as an example. Other examples are possible and may differ from what was described with respect to FIG. 5.

FIG. 6 is a diagram illustrating an example process 600 performed, for example, by a UE, in accordance with various aspects of the present disclosure. Example process 600 is an example where a UE (e.g., UE 120) performs 5G to 2G/3G two-step fallback.

As shown in FIG. 6, in some aspects, process 600 may include receiving, from a 4G/LTE device and via a 5G/NR base station, a first handover command message identifying at least one of a measurement configuration or a measurement gap for identifying a 2G/3G cell via which a UE is to perform a call (block 610). For example, the UE (e.g., using antenna 252, DEMOD 254, MIMO detector 256, receive processor 258, controller/processor 280, and/or the like) may receive a first handover command message. The first handover command message may identify at least one of a measurement configuration or a measurement gap. The UE may perform measurements based at least in part on the measurement configuration to identify a 2G/3G cell via which the UE is to perform a call. The UE may receive the first handover command message from a 4G/LTE device via a 5G/NR base station. For example, the UE may receive the first handover command message based at least in part on a tunnel from the 4G/LTE device via the 5G/NR base station. In some aspects, the 4G/LTE device and the 5G/NR base station may be collocated or may be the same base station. In some aspects, the UE may receive the first handover command message from a MME. For example, “4G/LTE device” may refer to the MME in some cases.

As shown in FIG. 6, in some aspects, process 600 may include transmitting, to the 4G/LTE device and via the 5G/NR base station, a measurement report regarding the 2G/3G cell based at least in part on the measurement configuration and/or the measurement gap (block 620). For example, the UE (e.g., using controller/processor 280, transmit processor 264, TX MIMO processor 266, MOD 254, antenna 252, and/or the like) may transmit a measurement report. The measurement report may identify a measurement regarding the 2G/3G cell. For example, the measurement report may be based at least in part on the measurement configuration and/or the measurement gap. In some aspects, the measurement report may be transmitted via the 5G/NR base station to the 4G/LTE device.

As shown in FIG. 6, in some aspects, process 600 may include tuning to the 2G/3G cell based at least in part on a second handover message, received from the 4G/LTE device via the 5G/NR base station, for performance of the call via the 2G/3G cell (block 630). For example, the UE (e.g., using antenna 252, DEMOD 254, MIMO detector 256, receive processor 258, controller/processor 280, and/or the like) may tune to the 2G/3G cell based at least in part on a second handover message. The second handover message may be received from the 4G/LTE device via the 5G/NR base station. The UE may tune to the 2G/3G cell to perform a call via the 2G/3G cell.

Process 600 may include additional aspects, such as any single aspect or any combination of aspects described below and/or in connection with one or more other processes described elsewhere herein.

In some aspects, the 5G/NR to 2G/3G handover is performed using the 4G/LTE device as a proxy, and wherein the UE does not access an LTE air interface when performing the 5G/NR to 2G/3G handover. In some aspects, the measurement report is encapsulated in a 4G/LTE radio resource control (RRC) message, and wherein the 4G/LTE RRC message is encapsulated in a 5G/NR RRC message. In some aspects, the measurement report is encapsulated in a container that is transparent to the 5G/NR base station.

In some aspects, at least one of the first handover command message or the second handover message is encapsulated in a container that is transparent to the 5G/NR base station.

In some aspects, the UE may provide, to a 4G/LTE network device via the 4G/LTE device, a tracking area update (TAU) message for configuration of a packet-switched handover of the UE to the 2G/3G cell. The UE may perform a routing area update (RAU) for the packet-switched handover of the UE to the 2G/3G cell based at least in part on receiving a TAU accept message with the second handover message. In some aspects, the TAU message and the TAU accept message are non-access stratum (NAS) messages encapsulated in LTE radio resource control (RRC) containers.

In some aspects, the 2G/3G cell is a selected base station, and wherein the measurement report includes information regarding a plurality of 2G/3G cells including the selected base station. In some aspects, receiving the first handover command message comprises receiving a plurality of first handover command messages for a plurality of corresponding 2G/3G cells, wherein the plurality of corresponding 2G/3G cells includes the 2G/3G cell and wherein the first handover command corresponding to the 2G/3G cell is included in the plurality of first handover command messages. The UE may select the 2G/3G cell from the plurality of corresponding 2G/3G cells based at least in part on measurements associated with the plurality of corresponding 2G/3G cells. The UE may be configured to provide the measurement report regarding the 2G/3G cell based at least in part on selecting the 2G/3G cell from the plurality of corresponding 2G/3G cells. In some aspects, the UE is configured to tune to the 2G/3G cell based at least in part on enforcing the first handover command message corresponding to the 2G/3G cell.

In some aspects, the plurality of first handover command messages are received from a radio network controller via the 4G/LTE device. In some aspects, the UE may release an air interface connection with the 5G/NR base station. In some aspects, the 5G/NR base station is collocated with the 4G/LTE device.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a 4G/LTE device, in accordance with various aspects of the present disclosure. Example process 700 is an example where a 4G/LTE device (e.g., BS 110, 4G/LTE BS 110 of FIGS. 3A, 3B, 4A, 4B, and 5, an MME, etc.) performs a fallback from 5G/NR to 2G/3G without accessing an LTE air interface.

As shown in FIG. 7, in some aspects, process 700 may include providing a first message identifying a measurement configuration for identifying a 2G/3G cell via which a UE is to perform a call, wherein the first message is provided to the UE via a 5G/NR base station (block 710). For example, the 4G/LTE device (e.g., using controller/processor 240, transmit processor 220, TX MIMO processor 230, MOD 232, antenna 234, and/or the like) may provide a first message identifying a measurement configuration for identifying a 2G/3G cell via which a UE is to perform a call. The first message may be provided to the UE via a 5G/NR base station. For example, the first message may be provided in a container or a set of containers that is transparent to the 5G/NR base station.

As shown in FIG. 7, in some aspects, process 700 may include receiving a measurement report regarding the 2G/3G cell based at least in part on the measurement configuration and via the 5G/NR base station (block 720). For example, the 4G/LTE device (e.g., using antenna 234, DEMOD 232, MIMO detector 236, receive processor 238, controller/processor 240, and/or the like) may receive a measurement report regarding the 2G/3G cell based at least in part on the measurement configuration. The 4G/LTE device may receive the measurement report via a 5G/NR base station. For example, the UE may transmit the measurement report to the 5G/NR base station in a 5G/NR RRC container that encapsulates an LTE RRC container.

As shown in FIG. 7, in some aspects, process 700 may include providing a second message to configure handover of the UE to the 2G/3G cell to perform the call, wherein the second message is provided to the UE via the 5G/NR base station (block 730). For example, the 4G/LTE device (e.g., using controller/processor 240, transmit processor 220, TX MIMO processor 230, MOD 232, antenna 234, and/or the like) may provide a second message to configure handover. The second message may be provided to the UE via the 5G/NR base station. In some aspects, the second message may include a handover command and/or the like.

Process 700 may include additional aspects, such as any single aspect or any combination of aspects described below and/or in connection with one or more other processes described elsewhere herein.

In some aspects, the first message is provided based at least in part on a handover message, received from the 5G/NR base station, indicating that single-radio voice call continuity (SRVCC) is to be configured with regard to the call. In some aspects, the 4G/LTE device may provide a plurality of first messages identifying measurement configurations of a plurality of 2G/3G cells, wherein the measurement report regarding the 2G/3G cell is received based at least in part on selection of the 2G/3G cell by the UE

In some aspects, the 4G/LTE device may perform a multi-target handover preparation procedure with regard to the plurality of 2G/3G cells.

In some aspects, the measurement report includes measurement information regarding a plurality of 2G/3G cells including the 2G/3G cell, and the 2G/3G cell is selected for the handover based at least in part on the measurement information. In some aspects, the 4G/LTE device may receive, via the 5G/NR base station, a tracking area update (TAU) message for configuration of a packet-switched handover of the UE to the 2G/3G cell; configure the packet-switched handover of the UE to the 2G/3G cell; and provide a TAU accept message to cause the packet-switched handover of the UE to the 2G/3G cell

In some aspects, the TAU message is received in a first non-access stratum (NAS) container, and wherein the TAU accept message is provided in a second NAS container, and the first NAS container and the second NAS container are enclosed in containers transparent to the 5G/NR base station. In some aspects, at least one of the first message or the second message is encapsulated in a 4G/LTE radio resource control (RRC) message, and wherein the 4G/LTE RRC message is encapsulated in a 5G/NR RRC message.

In some aspects, the measurement report is encapsulated in a container that is transparent to the 5G/NR base station. In some aspects, at least one of the first message or the second message is encapsulated in a container that is transparent to the 5G/NR base station. In some aspects, the 5G/NR base station is collocated with the 4G/LTE device.

Although FIG. 7 shows example blocks of process 700, in some aspects, process 7 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
receiving, from a 4G/Long Term Evolution (LTE) device and via a 5G/New Radio (NR) base station, a first handover command message identifying at least one of a measurement configuration or a measurement gap for identifying a 2G/3G cell via which the UE is to perform a call,
wherein the first handover command message is associated with a 5G/NR to 2G/3G handover of the UE via 4G/LTE;
transmitting, to the 4G/LTE device and via the 5G/NR base station, a measurement report regarding the 2G/3G cell based at least in part on the measurement configuration and/or the measurement gap; and
tuning to the 2G/3G cell based at least in part on a second handover message, received from the 4G/LTE device via the 5G/NR base station, for performance of the call via the 2G/3G cell.

2. The method of claim 1, wherein the UE does not access an LTE air interface when performing the 5G/NR to 2G/3G handover.

3. The method of claim 1, wherein the measurement report is encapsulated in a 4G/LTE radio resource control (RRC) message, and wherein the 4G/LTE RRC message is encapsulated in a 5G/NR RRC message.

4. The method of claim 1, wherein the measurement report is encapsulated in a container that is transparent to the 5G/NR base station.

5. The method of claim 1, wherein at least one of the first handover command message or the second handover message is encapsulated in a container that is transparent to the 5G/NR base station.

6. The method of claim 1, further comprising:
providing a tracking area update (TAU) message for configuration of a packet-switched handover of the UE to the 2G/3G cell; and
performing a routing area update (RAU) for the packet-switched handover of the UE to the 2G/3G cell based at least in part on receiving a TAU accept message with the second handover message.

7. The method of claim 6, wherein the TAU message and the TAU accept message are non-access stratum (NAS) messages encapsulated in LTE radio resource control (RRC) containers.

8. The method of claim 1, wherein the 2G/3G cell is a selected base station, and wherein the measurement report includes information regarding a plurality of 2G/3G cells including the selected base station.

9. The method of claim 1, wherein receiving the first handover command message comprises:
receiving a plurality of first handover command messages for a plurality of corresponding 2G/3G cells, wherein the plurality of corresponding 2G/3G cells includes the 2G/3G cell and wherein the first handover command corresponding to the 2G/3G cell is included in the plurality of first handover command messages; and
wherein the method further comprises selecting the 2G/3G cell from the plurality of corresponding 2G/3G cells based at least in part on measurements associated with the plurality of corresponding 2G/3G cells, and
wherein the UE is configured to provide the measurement report regarding the 2G/3G cell based at least in part on selecting the 2G/3G cell from the plurality of corresponding 2G/3G cells.

10. The method of claim 9, wherein the UE is configured to tune to the 2G/3G cell based at least in part on enforcing the first handover command message corresponding to the 2G/3G cell.

11. The method of claim 9, wherein the plurality of first handover command messages are received from a radio network controller via the 4G/LTE device.

12. The method of claim 1, further comprising:
releasing an air interface connection with the 5G/NR base station.

13. The method of claim 1, wherein the 5G/NR base station is collocated with the 4G/LTE device.

14. A method of wireless communication performed by a 4G/Long Term Evolution (LTE) device, comprising:
providing a first message identifying a measurement configuration for identifying a 2G/3G cell via which a user equipment (UE) is to perform a call,
wherein the first message is provided to the UE via a 5G/New Radio (NR) base station;
receiving a measurement report regarding the 2G/3G cell based at least in part on the measurement configuration and via the 5G/NR base station; and
providing a second message to configure handover of the UE to the 2G/3G cell to perform the call,
wherein the second message is provided to the UE via the 5G/NR base station.

15. The method of claim 14, wherein the first message is provided based at least in part on a handover message indicating that single-radio voice call continuity (SRVCC) is to be configured with regard to the call.

16. The method of claim 14, wherein providing the first message comprises:
providing a plurality of first messages identifying measurement configurations of a plurality of 2G/3G cells,
wherein the measurement report regarding the 2G/3G cell is received based at least in part on selection of the 2G/3G cell by the UE.

17. The method of claim 16, further comprising:
performing a multi-target handover preparation procedure with regard to the plurality of 2G/3G cells.

18. The method of claim 14, wherein the measurement report includes measurement information regarding a plurality of 2G/3G cells including the 2G/3G cell, and
wherein the 2G/3G cell is selected for the handover based at least in part on the measurement information.

19. The method of claim 14, further comprising:
receiving, via the 5G/NR base station, a tracking area update (TAU) message for configuration of a packet-switched handover of the UE to the 2G/3G cell;
configuring the packet-switched handover of the UE to the 2G/3G cell; and
providing a TAU accept message to cause the packet-switched handover of the UE to the 2G/3G cell.

20. The method of claim 19, wherein the TAU message is received in a first non-access stratum (NAS) container, and wherein the TAU accept message is provided in a second NAS container,
wherein the first NAS container and the second NAS container are enclosed in containers transparent to the 5G/NR base station.

21. The method of claim 14, wherein at least one of the first message or the second message is encapsulated in a 4G/LTE radio resource control (RRC) message, and wherein the 4G/LTE RRC message is encapsulated in a 5G/NR RRC message.

22. The method of claim 14, wherein the measurement report is encapsulated in a container that is transparent to the 5G/NR base station.

23. The method of claim 14, wherein at least one of the first message or the second message is encapsulated in a container that is transparent to the 5G/NR base station.

24. The method of claim 14, wherein the 5G/NR base station is collocated with the 4G/LTE device.

25. A user equipment (UE) for wireless communication, comprising:
a memory and one or more processors operatively coupled to the memory, the memory and the one or more processors configured to:
receive, from a 4G/LTE device and via a 5G/NR base station, a first handover command message identifying at least one of a measurement configuration or a measurement gap for identifying a 2G/3G cell via which the UE is to perform a call,
wherein the first handover command message is associated with a 5G/NR to 2G/3G handover of the UE via 4G/LTE;
transmit, to the 4G/LTE device and via the 5G/NR base station, a measurement report regarding the 2G/3G cell based at least in part on the measurement configuration and/or the measurement gap; and
tune to the 2G/3G cell based at least in part on a second handover message, received from the 4G/LTE device via the 5G/NR base station, for performance of the call via the 2G/3G cell.

26. The UE of claim 25, wherein the UE does not access an LTE air interface when performing the 5G/NR to 2G/3G handover.

27. The UE of claim 25, wherein the measurement report is encapsulated in a 4G/LTE radio resource control (RRC) message, and wherein the 4G/LTE RRC message is encapsulated in a 5G/NR RRC message.

28. The UE of claim 25, wherein the measurement report is encapsulated in a container that is transparent to the 5G/NR base station.

29. The UE of claim 25, wherein at least one of the first handover command message or the second handover message is encapsulated in a container that is transparent to the 5G/NR base station.

30. A non-transitory computer-readable medium storing one or more instructions for wireless communication,
the one or more instructions, when executed by one or more processors of a user equipment (UE), causing the one or more processors to:
receive, from a 4G/LTE device and via a 5G/NR base station, a first handover command message identifying at least one of a measurement configuration or a measurement gap for identifying a 2G/3G cell via which the UE is to perform a call,
wherein the first handover command message is associated with a 5G/NR to 2G/3G handover of the UE via 4G/LTE;
transmit, to the 4G/LTE device and via the 5G/NR base station, a measurement report regarding the 2G/3G cell based at least in part on the measurement configuration and/or the measurement gap; and
tune to the 2G/3G cell based at least in part on a second handover message, received from the 4G/LTE device via the 5G/NR base station, for performance of the call via the 2G/3G cell.

31. The non-transitory computer-readable medium of claim 30, wherein the UE does not access an LTE air interface when performing the 5G/NR to 2G/3G handover.

32. The non-transitory computer-readable medium of claim 30, wherein the measurement report is encapsulated in a 4G/LTE radio resource control (RRC) message, and wherein the 4G/LTE RRC message is encapsulated in a 5G/NR RRC message.

33. The non-transitory computer-readable medium of claim 30, wherein the measurement report is encapsulated in a container that is transparent to the 5G/NR base station.

34. The non-transitory computer-readable medium of claim 30, wherein at least one of the first handover command message or the second handover message is encapsulated in a container that is transparent to the 5G/NR base station.

35. An apparatus for wireless communication, comprising:
means for receiving, from a 4G/Long Term Evolution (LTE) device and via a 5G/New Radio (NR) base station, a first handover command message identifying at least one of a measurement configuration or a measurement gap for identifying a 2G/3G cell via which the apparatus is to perform a call,
wherein the first handover command message is associated with a 5G/NR to 2G/3G handover of the apparatus via 4G/LTE;
means for transmitting, to the 4G/LTE device and via the 5G/NR base station, a measurement report regarding the 2G/3G cell based at least in part on the measurement configuration and/or the measurement gap; and
means for tuning to the 2G/3G cell based at least in part on a second handover message, received from the 4G/LTE device via the 5G/NR base station, for performance of the call via the 2G/3G cell.

36. The apparatus of claim 35, wherein the apparatus does not access an LTE air interface when performing the 5G/NR to 2G/3G handover.

37. The apparatus of claim 35, wherein the measurement report is encapsulated in a 4G/LTE radio resource control (RRC) message, and wherein the 4G/LTE RRC message is encapsulated in a 5G/NR RRC message.

38. The apparatus of claim 35, wherein the measurement report is encapsulated in a container that is transparent to the 5G/NR base station.

39. The apparatus of claim 35, wherein at least one of the first handover command message or the second handover message is encapsulated in a container that is transparent to the 5G/NR base station.

40. A 4G/Long Term Evolution (LTE) device for wireless communication, comprising:
a memory and one or more processors operatively coupled to the memory, the memory and the one or more processors configured to:
provide a first message identifying a measurement configuration for identifying a 2G/3G cell via which a user equipment (UE) is to perform a call,
wherein the first message is provided to the UE via a 5G/New Radio (NR) base station;
receive a measurement report regarding the 2G/3G cell based at least in part on the measurement configuration and via the 5G/NR base station; and
provide a second message to configure handover of the UE to the 2G/3G cell to perform the call,
wherein the second message is provided to the UE via the 5G/NR base station.

41. The 4G/LTE device of claim 40, wherein the first message is provided based at least in part on a handover message indicating that single-radio voice call continuity (SRVCC) is to be configured with regard to the call.

42. The 4G/LTE device of claim 40, wherein at least one of the first message or the second message is encapsulated in a 4G/LTE radio resource control (RRC) message, and wherein the 4G/LTE RRC message is encapsulated in a 5G/NR RRC message.

43. The 4G/LTE device of claim 40, wherein the measurement report is encapsulated in a container that is transparent to the 5G/NR base station.

44. The 4G/LTE device of claim 40, wherein at least one of the first message or the second message is encapsulated in a container that is transparent to the 5G/NR base station.

45. A non-transitory computer-readable medium storing one or more instructions for wireless communication,
the one or more instructions, when executed by one or more processors of a 4G/Long Term Evolution (LTE) device, causing the one or more processors to:
provide a first message identifying a measurement configuration for identifying a 2G/3G cell via which a user equipment (UE) is to perform a call,
wherein the first message is provided to the UE via a 5G/New Radio (NR) base station;
receive a measurement report regarding the 2G/3G cell based at least in part on the measurement configuration and via the 5G/NR base station; and
provide a second message to configure handover of the UE to the 2G/3G cell to perform the call,
wherein the second message is provided to the UE via the 5G/NR base station.

46. The non-transitory computer-readable medium of claim 45, wherein the first message is provided based at least in part on a handover message indicating that single-radio voice call continuity (SRVCC) is to be configured with regard to the call.

47. The non-transitory computer-readable medium of claim 45, wherein at least one of the first message or the second message is encapsulated in a 4G/LTE radio resource control (RRC) message, and wherein the 4G/LTE RRC message is encapsulated in a 5G/NR RRC message.

48. The non-transitory computer-readable medium of claim 45, wherein the measurement report is encapsulated in a container that is transparent to the 5G/NR base station.

49. The non-transitory computer-readable medium of claim 45, wherein at least one of the first message or the second message is encapsulated in a container that is transparent to the 5G/NR base station.

50. An apparatus for wireless communication, comprising:
means for providing a first message identifying a measurement configuration for identifying a 2G/3G cell via which a user equipment (UE) is to perform a call,
wherein the first message is provided to the UE via a 5G/New Radio (NR) base station;
means for receiving a measurement report regarding the 2G/3G cell based at least in part on the measurement configuration and via the 5G/NR base station; and
means for providing a second message to configure handover of the UE to the 2G/3G cell to perform the call,
wherein the second message is provided to the UE via the 5G/NR base station.

51. The apparatus of claim 50, wherein the first message is provided based at least in part on a handover message indicating that single-radio voice call continuity (SRVCC) is to be configured with regard to the call.

52. The apparatus of claim 50, wherein at least one of the first message or the second message is encapsulated in a 4G/LTE radio resource control (RRC) message, and wherein the 4G/LTE RRC message is encapsulated in a 5G/NR RRC message.

53. The apparatus of claim 50, wherein the measurement report is encapsulated in a container that is transparent to the 5G/NR base station.

54. The apparatus of claim 50, wherein at least one of the first message or the second message is encapsulated in a container that is transparent to the 5G/NR base station.
